(19) United States
(12) Patent Application Publication
(10) Pub. No.: US 2022/0309473 A1
(43) Pub. Date: Sep. 29, 2022

(54) SERVICE STATION FOR A VEHICLE

(71) Applicant: Volkswagen Aktiengesellschaft, Wolfsburg (DE)

(72) Inventors: Kira Weissbrich, Braunschweig (DE); Frank Petershagen, Hannover (DE); Eva-Maria Kleinemas, Hannover (DE)

(21) Appl. No.: 17/611,040

(22) PCT Filed: May 6, 2020
(86) PCT No.: PCT/EP2020/062631

§ 371 Date: Nov. 12, 2021

(30) Foreign Application Priority Data
May 13, 2019 (DE) 10 2019 206 920.7

(51) Int. Cl. G06Q 10/00; G06Q 10/02; B60L 53/66; B60L 53/65

(52) U.S. Cl. CPC G06Q 10/20; G06Q 10/02; B60L 53/66; B60L 53/65

(57) ABSTRACT

A service station for a vehicle, wherein the service station includes at least one communication module configured for communication with the vehicle, a control unit, and a plurality of service modules designed for autonomously carrying out a service action on the vehicle. First information regarding a service requirement of the vehicle may be received, second information regarding the utilization of the service modules may be received, and at least one available service module is identified on the basis of the first information and the second information. Booking information is sent to the at least one identified service module and location information of the at least one identified service module is sent to the vehicle.

### CROSS REFERENCE TO RELATED APPLICATION

The present application claims priority to International Patent Application No. PCT/EP2020/062631 to Weissbrich, et al., titled “Method for Operating a Service Station for a Vehicle, and System for Carrying out the Method according To the Invention”, filed May 6, 2020, which claims priority to German Patent App. No 10 2019 206 920.7, to Weissbrich, et al., filed May 13, 2019, the contents of each being incorporated by reference in their entirety herein.

### FIELD OF TECHNOLOGY

The present disclosure relates to technologies and techniques for operating a service station for a vehicle, in particular for an autonomous electric vehicle of a vehicle fleet, comprising for example, a plurality of self-driving electric vehicles of a car sharing provider. The present disclosure further relates to a system for carrying out the method according to the present disclosure.

### BACKGROUND

Today's vehicles already have a plurality of assistance systems that support the driver in a computer-based manner and in a plurality of driving situations. Such assistance systems can rely on sensors to collect a wide range of measurement data that far exceeds the sensory capabilities of humans. In addition, the speed of these assistance systems significantly exceeds human reaction time. Known driver assistance systems are, for example, lane departure warning systems, brake assistants with pedestrian detection and adaptive cruise control, especially for traffic jams.

By using such assistance systems, the driver's autonomy with regard to his driving decisions is increasingly being transferred to the vehicle or to control units operating within it. The culmination of these developments is an autonomously driving vehicle that can maneuver completely without intervention by a human. Using such an autonomously driving vehicle enables fully automated passenger transport.

Up to now, such autonomously driving vehicles have generally been registered to individuals and/or do not have a road permit without additional monitoring by a driver. In terms of maintenance and care, these autonomously driving vehicles thus differ little from other privately owned vehicles. Generally, the owner(s) will take care of the maintenance of and energy supply for the vehicle.

However, already today various mobility concepts exist, in particular in urban centers. With the so-called car sharing, a plurality of users accesses the vehicles in a vehicle fleet independently of one another and for a limited time period.

By restricting the fleet vehicles to a specific user only for the period of actual use, unused vehicle parking time can be minimized.

Car sharing concepts are also known for other vehicles such as bicycles, scooters or vans. Without being limited to passenger cars, representatively only the term car sharing is used hereinafter. Moreover, the present disclosure may also be used in the context of ride pooling and ride hailing.

Furthermore, an autonomous vehicle fleet may refer to a fleet of private vehicles that are temporarily made available for driving services, in particular for autonomous driving services. In the above-mentioned cases, a fleet operator means the provider of an application, wherein the application is used to connect users and providers of driving services. In some circumstances, the fleet operator may be a vehicle manufacturer or service partner of such.

A distinction is made, in particular, between centralized and decentralized car sharing concepts. With centralized car sharing concepts, vehicle use must always start and end at specific stations. It is thus substantially a short-term traditional vehicle rental. With decentralized car sharing concepts on the other hand, vehicle use may start and end at arbitrary points within an operating area of the fleet provider. In particular decentralized car sharing concepts have the potential to significantly minimize the total number of vehicles required, since from a sufficient number of users and vehicles, the fleet vehicles will be available in a self-organized manner and with a sufficient concentration in the operating area.

However, in particular with decentralized car sharing concepts, energy supply for, and maintenance and care of the vehicles pose a challenge. On the one hand, the fleet provider's employees may be utilized for filling and cleaning the fleet vehicles. This, however, significantly increases personnel costs and thus the costs of the car sharing concept. Alternatively, the users of the autonomous vehicles may be induced with appropriate incentives to carry out the respectively necessary service trips. However, this carries the risk of insufficient maintenance or vehicle breakdowns. In addition to the operability of the individual vehicles, it is further necessary to maintain the functionality of the fleet. In particular the decentralized car sharing concepts require a certain minimum number of operational vehicles at all times. This is the only way to ensure sufficient availability of vehicles for the users.

### SUMMARY

Aspects of the present disclosure are directed to overcoming or at least decreasing the problems of the state of the art and to provide a solution for carrying out service actions on a vehicle, for example, an autonomous fleet vehicle, that takes into account the requirement for functionality of the entire fleet.

An aspect of present disclosure is directed to a method for operating a service station for a vehicle, and a system for carrying out the method according to the present disclosure according to the independent claims. Preferred further embodiments are the subject of the corresponding related dependent claims.

Other aspects of the present disclosure relate to a method for operating a service station for a vehicle, wherein the vehicle preferably is an autonomous fleet vehicle.

In some examples, the service station used in the method according to the present disclosure is designed to be used in the method according to the present disclosure and, for this purpose, has a (second) communication module configured for communication with the vehicles and/or a server of a fleet operator. The (second) communication module is, for example, a WLAN or cellular module and is preferably designed for carrying out Car2Car or Car2X communication. The second communication module is preferably designed to communicate according to a communication protocol used by the first communication module and/or by the server. The service station according to the present disclosure further has a (second) control unit designed to carry out the method steps of the method according to the present disclosure based on data processing, as described in detail below. The service station further has a plurality of service modules designed to autonomously carry out a service action on the vehicle. The service module is more preferably designed as a robot or has robotics. The specific design of the service module of the service station may vary. The control unit is, in particular, designed for controlling the communication module and the service module of the service station.

The various embodiments of the invention mentioned in this application can be advantageously combined with each other, unless otherwise specified in the individual case.

### BRIEF DESCRIPTION OF THE DRAWINGS

The present disclosure is explained below using exemplary embodiments with reference to the associated drawings. In the figures:

FIG. 1 is a schematic illustration of a system for carrying out methods according to the invention, the system including an autonomous vehicle, a service station, service modules and a server, under some aspects of the present disclosure;

FIG. 2 is a schematic illustration of an operating area for carrying out methods utilizing the system shown in FIG. 1, under some aspects of the present disclosure;

FIG. 3 is a schematic flow diagram of a method according to a form of execution, under some aspects of the present disclosure;

FIG. 4 is a schematic illustration of a first service module for interior cleaning of the vehicle, under some aspects of the present disclosure;

FIG. 5 is a schematic illustration of a second service module for exterior cleaning of the vehicle, under some aspects of the present disclosure;

FIG. 6 is a schematic illustration of a service station, under some aspects of the present disclosure; and

FIG. 7 is schematic illustration of another service station t, under some aspects of the present disclosure.

### DETAILED DESCRIPTION

In some examples, first information about a service need of the vehicle is received. The first information may include information about a condition characteristic of the vehicle, which indicates that an actual condition of the vehicle deviates in a certain characteristic from a desired condition of the same. The desired condition is specified for all or only for specific vehicles. The type of service need generally is predefined by the type or classification of the desired condition. In addition, the type of the service need may also be defined by vehicle-specific characteristics such as the presence of an electric motor and/or a combustion engine, which are then considered in the first information. Further preferably, the first information specifies the degree of the service need. The first information is received from the vehicle itself, for example, directly or via a base station of a cellular network, or from a server of a fleet operator. The processing of the first information may be carried out by the communication module of the service station while controlled by the control unit of the service station.

In some examples, second information about the utilization of the service module is further received. The second information is received by the service modules themselves, for example, directly via a data bus or a wireless communication, or via a base station of a cellular network. Alternatively, the second information is also received from a server of a fleet operator. The second information may include information about time periods in which the respective service module is available for a service action. These time periods are, for example, limited by time periods that are already booked for service actions at other service modules. The second information may include details about an expected utilization of the service modules, for example for time periods further in the future for which no actual bookings have yet been made. The second information processing may be carried out by the communication module of the service station while controlled by the control unit of the service station.

In some examples, at least one available service module is identified based on the first information and the second information. Further, the available service module is a service module suitable for carrying out the service action specified in the first information, meaning, a service module configured (designed) for carrying out the determined service action. The suitable service module is, in particular, suitable to carry out the service action fully or partially autonomous. To autonomously carry out is understood to mean to carry out without human intervention (apart from programming, maintenance and servicing of the service station). The suitability of the service module results, in particular, from the equipment of the same, i.e. from the means available in the service module for carrying out a service action, such as cleaning, refilling of an energy storage unit and/or carrying out maintenance or a repair.

In some examples, a booking information is transmitted to the at least one identified service module. The booking information specifies, in particular, a time period in which the service module is need for carrying out a service action on the vehicle. Since the available service module was identified based on the second information, e.g., taking into account the previously unbooked time periods of the service module, the booking information generally concerns a previously unbooked time period of the service module. A confirmation of the booking information from the service module to the service station is generally not necessary. However, in order to avoid errors with simultaneous bookings, a confirmation of the booking information is preferably received in the method according to the present disclosure. The booking information is preferably transmitted directly via a data bus or a wireless communication or via a base station of a cellular network. Alternatively, the booking information is transmitted via the server.

In some examples, location information of the at least one identified service module is also transmitted to the vehicle. In the context of the present disclosure, the service modules are either arranged in the service stations, for example, as individual spatial areas within a building and/or associated with the service station such as different buildings at one site. Depending on the specific application, the positioning information preferably comprises the geographic location and/or the coordinates of the service module itself or of a service station containing the service module. For example, with a service module arranged in a building, transmitting a position of an entrance into the building is sufficient because the vehicle is guided (remote-controlled) within the building, for example. With service modules arranged at a site, the position of the service module is transmitted directly depending on the security measures at the site.

A method according to the present disclosure is preferably carried out within a service infrastructure having at least one service station and a plurality of service modules arranged in an operational zone of the autonomous vehicle fleet. The number and concentration of the service stations and service modules is preferably adapted to the number of autonomous fleet vehicles and to the need for service actions or the frequency of required service actions. Each of the service stations is preferably designed for communication with the autonomous vehicles, the service module, a server of the fleet operator and/or with other service stations. The embodiment of the service stations is described in detail below.

In the context of the method according to the present disclosure, the available (and suitable) service module is identified by a service station to which information about a service need of a vehicle has been transmitted by a vehicle or the server. Furthermore, the service station takes into account the utilization of the service modules. Suitability is preferably determined automatically, for example database-based, by means of at least one look-up table, LUT, by means of at least one algorithm and/or by means of an artificial intelligence. Alternatively or additionally, the at least on suitable service module is identified at least in part via a user input, for example by an employee of the fleet operator in response to a prompt.

In response to the aforementioned steps of the method according to the present disclosure, the vehicle autonomously drives to the identified available (and suitable) service module. The drive takes place immediately after the available (and suitable) service module has been identified or according to the booking information. Provided that the autonomous vehicle in question arrives at the available and suitable service module or service station, respectively, the determined service action corresponding to the service need is carried out partially or fully autonomously, which may include guiding the vehicle to the available service module.

In the method according to the present disclosure assigning the vehicle in question to the identified available (and suitable) service module is thus necessary. In some examples, the first information may include an identifier of the vehicle. The identifier preferably uniquely identifies the vehicle, such as a vehicle identification number, or uniquely identifies at least the (first) communication module of the vehicle such as a MAC number. When, in the method according to the present disclosure, the service station transmits the booking information to the identified service station, this booking information preferably contains the identifier of the vehicle.

In a further preferred form of execution of the method according to the present disclosure, the vehicle is identified based on the identifier upon arrival of said vehicle at the at least one identified service module. The service module received the identifier already with the booking information and the vehicle is in possession of the identifier anyway. According to this embodiment, the identifier is thus further transmitted from the arrived vehicle to the identified service module or vice versa, particularly preferably by means of the first communication module of the vehicle and a third communication module of the service module, which communicate according to the same protocol. Finally, the received identifier is compared by the vehicle or the service module with the identifier previously stored there. This form of execution advantageously enables assigning the vehicle to the service action booked in the service module upon arrival of said vehicle. The service action is preferably carried out only if an identity of the identifiers has been determined. This form of execution is carried out provided that the positioning information contained the coordinates of the service module.

In an also preferred form of execution of the method according to the present disclosure, which is in particular carried out if the positioning information comprises the coordinates of a service station containing the service module, the vehicle is identified upon arrival at the service station specified in the positioning information. This form of execution comprises the transmission of the identifier from the arrived vehicle to the service module or vice versa, particularly preferably by means of the first communication module of the vehicle and a second communication module of the service station, which communicate according to the same protocol. The received identifier is then compared by the vehicle or the service station with the identifier previously stored there. Provided the comparison of the identifiers shows that they are identical, the service action booked for the vehicle and the associated service module are identified. The service station then transmits position information of the at least one identified service module and/or navigation data to the vehicle.

Another preferred form of execution preferably takes place when the service station includes multiple service modules arranged on a site. The positioning information preferably comprises the coordinates of the booked service module. Using the coordinates, the vehicle identifies a route and the necessary maneuvers to the service module. Alternatively, the navigation data preferably comprises route guidance to the service module and/or the maneuvers necessary to travel the route already identified by the service station. The navigation data also preferably comprises instructions for remotely controlling the vehicle, in other words, the service station controls the longitudinal and lateral guidance of the vehicle within the service station.

According to the form of execution, a drive of the vehicle to one of the at least one identified service module within the service station is monitored. The drive is preferably an autonomous or remote-controlled drive of the vehicle. The monitoring most preferably comprises tracking a location of the vehicle within the service station as well as controlling infrastructure components to enable the vehicle to pass through them. The infrastructure components are preferably doors or gates that are opened. Also preferably, the infrastructure components are light signals or barriers, etc., which temporarily block a vehicle's travel route for other vehicles or for people.

As a result of the above two forms of execution of the method according to the present disclosure, the vehicle reaches the service module previously identified (and suitable) in the method according to the present disclosure. Upon arrival at the service module and identifying the vehicle based on the vehicle identifier, the actual service action is carried out as described below.

In some examples, at least one vehicle setting is transmitted from the at least one identified service module to the vehicle, in particular from the third communication module of the service module to the first communication module of the vehicle. The at least one vehicle setting relates, for example, to the closing of the vehicle windows and the folding-in of the mirrors prior to an exterior cleaning. Alternatively or additionally, the at least one vehicle setting relates, for example, to the moving of a vehicle seat prior to an interior cleaning. In other words, the vehicle setting causes at least one component of the vehicle to be adjusted in preparation of and/or to enable the service action.

Subsequently, the at least one identified (and suitable) service module, in particular its third communication module, receives a notification from the vehicle, in particular the first communication module of the vehicle. The notification contains a confirmation of the implementation of the at least one vehicle setting, or information about the non-implementation of the at least one vehicle setting. For example, it may not be possible for the vehicle to move a vehicle seat if there are still objects, for example, a child seat or the like, in the vehicle.

Finally, based on the received booking information and the received notification, the service module carries out at least one service action on the vehicle.

The booking information initially contains information on all service actions required by the vehicle according to the vehicle's service needs. Based on the notification, the service module further determines whether it is currently possible to carry out the service action and accordingly carries out the service action or not.

For example, a booking information specifies exterior cleaning and interior cleaning as the service actions to be carried out on a vehicle. With regard to exterior cleaning, the service module has transmitted the vehicle setting “Closed side windows” to the vehicle. In response, the vehicle closed the side windows and sent a notification to the service module confirming that the vehicle setting had been implemented. With regard to interior cleaning, the service module has transmitted the vehicle setting “Move vehicle seats back” to the vehicle. However, since objects in the vehicle do not allow the seats to be moved, the vehicle has sent a notification to the service module that the vehicle setting has not been implemented. In response, the vehicle carries out the exterior cleaning but not the interior cleaning, for example because a cleaning robot cannot be brought into the vehicle when the seats are not moved back.

In a further preferred form of execution of the method according to the present disclosure, an occupancy indication is also transmitted from the at least one identified service module to the control unit of the service station at the start of the service action. Also preferably, in the method according to the present disclosure, an availability indication is transmitted from the at least one identified service module to the control unit of the service station after completion of the service action. Particularly preferably, the occupancy indication and/or the availability indication are taken into account by the service station for determining the utilization of the service modules. In other words, the occupancy indication and the availability indication are special embodiments of the second information. The second information preferably further comprises additional information, and include, for example, booking information of other service stations and/or information on an estimated future occupancy of the service module.

In the context of the present application, a transmitted service need of the vehicle is preferably understood to mean that the vehicle is soiled. The soiling may concern the interior or the exterior of the vehicle. A transmitted service need of the vehicle relates also preferably to a low level of the vehicle's energy storage unit, for example a low State of Charge, SOC, of an electrical energy storage unit or a low level of a tank for fossil fuels or hydrogen. Also preferably, the transmitted service need is an error message of the vehicle, particularly preferably an OBD2 error message. Also preferably, the transmitted service need is a notification of expiration of a service interval, for example, for an oil change.

In the aforementioned preferred forms of execution, a degree of service need relates, for example, to a degree of soiling (interior or exterior), the presence of an alternative energy storage unit (such as in a hybrid vehicle), or the type of error reported (such as when distinguishing a red warning light from a yellow warning light). In other words, the first information includes data on a soiling of the vehicle, a low level of an energy storage unit, an error message of the vehicle, and/or a service interval of the vehicle. Furthermore, the first information preferably includes data on a degree of service need as described.

In the method according to the present disclosure, a service action is an action on the vehicle to change it from the present actual condition to a desired target condition. A type of service action is preferably determined on the basis of the type of service need determined, so that a service action is understood to mean an action on the vehicle corresponding to a specific service need. For example, cleaning the vehicle corresponds to a soiling of the vehicle. A low fill level of the energy storage unit preferably corresponds to the energy storage unit being refilled. A detected error message of the vehicle preferably corresponds to the vehicle being maintained or repaired. Furthermore, a degree of service action is preferably determined on the basis of a degree of the determined service need. For example, a degree of soiling is used to determine whether exterior or interior cleaning should be performed, the latter possibly with or without upholstery cleaning. Also preferably, the degree of an error message for low air pressure in a tire can be used to determine whether the tire needs to be refilled or replaced.

The method steps of the method according to the present disclosure may be implemented by electrical or electronic parts or components (hardware), by firmware (ASIC), or may be realized by executing a suitable program (software). Also preferably, the method according to the present disclosure is realized, or implemented, by a combination of hardware, firmware and/or software.

For example, individual components for carrying out individual method steps are designed as a separate integrated circuit or are arranged on a common integrated circuit. Individual components configured for carrying out individual method steps are further preferably arranged on a (flexible) printed circuit board (FPCB/PCB), a tape carrier package (TCP) or another substrate.

The individual method steps of the method according to the present disclosure are further preferably designed as one or more processes running on one or more processors in one or more electronic computers, which processes are generated by executing one or more computer programs. The computers are preferably designed to interact with other components, such as a communication module as well as one or more sensors and/or cameras, to realize the functionalities described herein. The commands of the computer programs are preferably stored in a memory, such as a RAM element. However, the computer programs may also be stored in a non-volatile storage medium, such as a CD-ROM, flash memory or the like.

Furthermore, it is apparent to the person skilled in the art that the functionalities of a several computers (data processing devices) may be combined or may be combined in a single device, or that the functionality of a particular data processing device may be distributed among a plurality of devices to carry out the steps of the method according to the invention, without deviating from the method according to the invention described above.

Another aspect of the present disclosure relates to a computer program comprising commands which, when the program is executed by a computer, such as a second control unit of a service station, cause the computer to execute the method according to the present disclosure; the service station method according to the present disclosure comprising the steps of: receiving first information about a service need of the vehicle; receiving second information about a utilization of the service module; identifying an available service module based on the first information and the second information; and transmitting booking information to the at least one identified service module and location information of the at least one identified service module to the vehicle.

Another aspect of the present disclosure relates to a computer-readable storage medium comprising commands which, when the program is executed by a computer, such as a second control unit of a service station, cause the computer to execute the method according to the present disclosure; the service station method according to the present disclosure comprising the steps of: receiving first information about a service need of the vehicle; receiving second information about a utilization of the service module; identifying an available service module based on the first information and the second information; and transmitting booking information to the at least one identified service module and location information of the at least one identified service module to the vehicle.

Another aspect of the present disclosure relates to a system for carrying out a service action on a vehicle, in particular a system for carrying out a service action on a vehicle according to the method according to the present disclosure.

In some examples, a system according to the present disclosure has at least an autonomously driving vehicle having at least a first sensor for acquiring ambient data and at least one second sensor for acquiring vehicle data. The at least one first sensor enables acquiring ambient or environmental information and the at least one second sensor enable acquiring vehicle-specific information. The vehicle further has a drive system designed for carrying out autonomous driving maneuvers. The drive system is preferably designed for complete lateral and longitudinal guidance of the vehicle.

The vehicle further has a (first) communication module configured for establishing at least one communication connection. The communication module is preferably a WLAN or cellular module and is preferably designed for carrying out Car2Car or Car2X communication. The vehicle further has an energy storage unit, for example, a battery system, and/or a fuel or hydrogen tank. The vehicle further has a control unit designed for carrying out the method steps of the vehicle during the operation of the system according to the present disclosure.

The system according to the present disclosure has at least one service station. The at least one service station has at least one (second) communication module configured for communicating with the at least one vehicle and optionally a server of a fleet operator. The second communication module is preferably a WLAN or cellular module and is preferably designed for carrying out Car2Car or Car2X communication. The service station has a (second) control unit configured for carrying out the method steps of the method according to the present disclosure.

The system according to the present disclosure further has a plurality of service modules designed to autonomously carry out a service action on the vehicle. The service modules are arranged in the service station, for example in different areas of a building, or are associated with the service station, for example in different sections of a site. Each service module has a third communication module. The third communication module is preferably a WLAN or cellular module and is preferably designed for carrying out Car2Car or Car2X communication. Each service module further has a third control unit designed for carrying out the method steps of the service module in the method according to the present disclosure. Each service module further has one or more means for carrying out a service action.

The at least one service module particularly preferably has at least one first service module designed for carrying out an interior cleaning of the vehicle. The first service module preferably is a robotic arm carrying tools suitable for cleaning the interior of the vehicle. The robotic arm is preferably designed to be introduced into the vehicle interior through an open door or an open window of the vehicle. The tools are, for example, a vacuum cleaner nozzle, an upholstery brush, an applicator for applying a cleaning agent and/or means for cleaning trays and/or window panes. In an alternatively preferred embodiment, the first service module has a mobile cleaning robot designed to enter the vehicle interior through an open door or an open window. The mobile cleaning robot preferably has tools that are preferably suitable for interior cleaning such as a vacuum cleaner nozzle, an upholstery brush, an applicator for applying a cleaning agent and/or means for cleaning trays and/or window panes. The mobile cleaning robot is designed to carry out an interior cleaning autonomously and/or with doors and windows closed.

The at least one service module also preferably has at least one second service module designed for carrying out an exterior cleaning of the vehicle. The second service module is preferably designed like an automatic car wash such as know from the prior art and preferably has nozzles for applying at least one cleaning liquid, brushes or cloths for removing dirt from the vehicle and/or a dryer for drying the vehicle. The second service module particularly preferably also has further washing elements, such as brushes specially designed for rim washing and/or means for applying wax. The second service module also preferably has means for transporting the vehicle inside the module.

The service station according to the present disclosure also preferably additional has at least one third service module designed for filling the energy storage unit of the vehicle.

The system according to the present disclosure further preferably has at least one server configured for communicating with the at least one autonomous vehicle and at least one service station. The server preferably is a server of a data processing center of a provider of car sharing services (fleet operator), a provider of cleaning services or a vehicle manufacturer. The server has in particular a (fourth) communication module designed as a WLAN or cellular module and is preferably designed for carrying out Car2Car or Car2X communication. The server is further designed for facilitating communication between the vehicle and the service station. In other words, the server is designed to forward data received from the service station or vehicle to the vehicle or service station.

The server is also preferably designed to determine a utilization of the autonomous vehicle fleet. In this context, the vehicle described with reference to the method according to the present disclosure is part of the autonomous vehicle fleet. The server is configured for communicating with the autonomous vehicles. According to a preferred form of execution, a utilization of the autonomous vehicles is determined by the server based on utilization data generated by the vehicles. The utilization data can take into account the number of user requests, average driving times, and trip lengths. Likewise, additional information that makes high demand likely, such as the beginning and end of a major event, such as a sporting event, concert, etc., can be taken into account.

In the context of the method according to the present disclosure, the vehicle is further designed to transmit first information received from the vehicle to the service station based on the utilization of the vehicle fleet. The server is in particular designed to forward the first information only during periods of low utilization, for example, when utilization is below a predetermined limit. The server also preferably forwards only first information with an indicator of urgency, for example a need for repair or a lack of fuel, etc., to the service station even when the utilization is above the predetermined limit. Thus, maintaining the operability of the vehicle fleet is taken into account in the system and method according to the present disclosure.

In some examples, the service station of the system according to the present disclosure may include at least one first service module designed for carrying out an interior cleaning of the vehicle. The first service module preferably is a robotic arm carrying tools suitable for cleaning the interior of the vehicle. The robotic arm is preferably designed to be introduced into the vehicle interior through an open door or an open window of the vehicle. The tools are, for example, a vacuum cleaner nozzle, an upholstery brush, an applicator for applying a cleaning agent and/or means for cleaning trays and/or window panes.

In an alternatively preferred embodiment, the first service module has a mobile cleaning robot designed to enter the vehicle interior through an open door or an open window. The mobile cleaning robot further preferably has tools that are preferably suitable for interior cleaning such as a vacuum cleaner nozzle, an upholstery brush, an applicator for applying a cleaning agent and/or means for cleaning trays and/or window panes. The mobile cleaning robot is designed to carry out an interior cleaning autonomously and/or with doors and windows closed.

The service station of the system according to the present disclosure alternatively or additionally also preferably has at least one second service module designed for carrying out an exterior cleaning of the vehicle. The second service module is preferably designed like an automatic car wash such as know from the prior art and preferably has nozzles for applying at least one cleaning liquid, brushes or cloths for removing dirt from the vehicle and/or a dryer for drying the vehicle. The second service module particularly preferably also has further washing elements, such as brushes specially designed for rim washing and/or means for applying wax. The second service module also preferably has means for transporting the vehicle inside the module.

The service station of the system according to the present disclosure alternatively or additionally also preferably has at least one third service module designed for filling the energy storage unit of the vehicle. The third service module has, in particular, its own energy storage unit, for example a battery or a fuel tank, or a connection to a corresponding supply network, for example to a power grid or a fuel supply line. The third service module further has a connection module for connecting to a refilling element of the vehicle. The refilling element of the vehicle is, for example, a filler neck or a charging socket. Furthermore, the connecting element preferably has a robotic arm having a filling element adapted to the refilling element of the vehicle. The filling element is advantageously connected to the energy storage unit via a supply line. The third service module is particularly preferably designed for hybrid vehicles and has, for example, a first filling element connected to the power supply system for connection to a charging socket of the vehicle, and a second filling element connected to a fuel supply line for connection to a filler neck of the vehicle. A first service station according to the present disclosure may have one or more further service modules in addition to the first, second, third and fourth service module.

Further preferred, the service station of the system according to the present disclosure has a fourth service module designed for changing the tires of the vehicle. The fourth service module has a storage facility for a plurality of spare wheels and an automatic shelving system or the like for automatically removing a set of spare wheels from the storage facility. The fourth service module further preferably has a robotic arm for automatically changing the tires of the vehicle using the spare wheels.

Further preferred embodiments of the present disclosure result from the other features mentioned in the dependent claims.

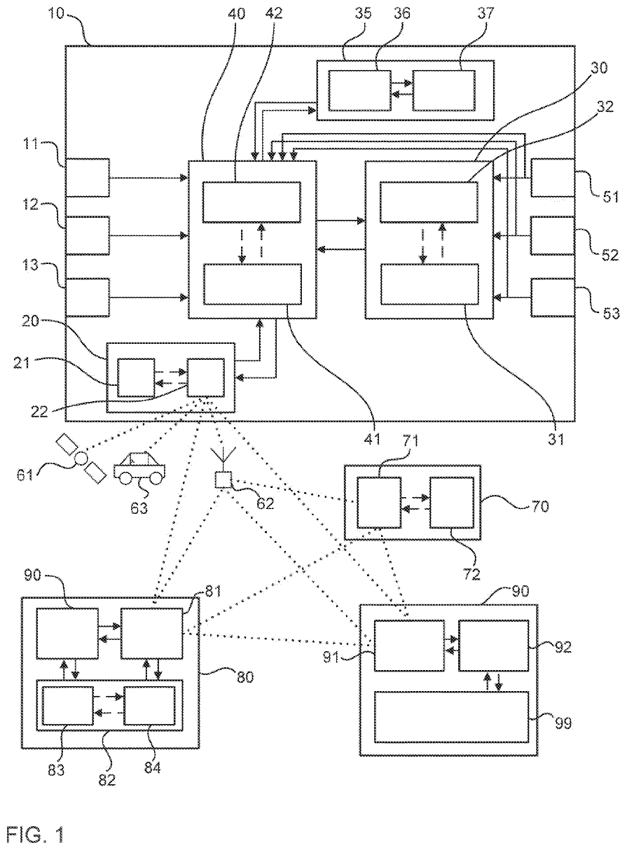

FIG. 1 shows a schematic illustration of a system for carrying out the method according to the present disclosure, wherein the system includes an autonomous vehicle 10, a server 70, a service station 80, and service modules 90.

FIG. 1 shows a block diagram of a two-track vehicle 10 with electric motor 37. The vehicle 10 comprises a plurality of first sensors, in particular a first sensor 11, a second sensor 12 and a third sensor 13. The first sensors 11, 12, 13 are configured for detecting environmental information or ambient information of the vehicle 10 and comprise, for example, temperature sensors for detecting an ambient temperature, a camera for capturing an image of an environment immediately surrounding the vehicle 10, a microphone for capturing noises in an environment immediately surrounding the vehicle 10, distance sensors such as ultrasonic sensors for detecting distances to objects surrounding the vehicle 10. The first sensors 11, 12, 13 transmit the ambient signals detected or captured by them to a first control unit 40 of the vehicle 10.

The vehicle 10 further has a plurality of second sensors, in particular a fourth sensor 51, a fifth sensor 52 and a sixth sensor 53. The second sensors 51, 52, 53 are sensors for detecting condition data concerning the vehicle 10 itself such as current location and movement information of the vehicle 10. The second sensors 51, 52, 53 thus are speed sensors, acceleration sensors, tilt sensors, interior motion sensors, pressure sensors in the vehicle seats or the like.

Moreover, at least some of the second sensors 51, 52, 53 are designed for capturing a degree of soiling of the vehicle 10. The second sensors 51, 52, 53 designed for this purpose include, for example, an interior camera for capturing image signals of the vehicle interior, a dashboard camera for capturing image signals of the engine hood, a camera in a side mirror for capturing image signals of a side door of the vehicle, and other sensors for detecting soiling, for example on the basis of a degree of reflection of the vehicle paint or the like. The second sensors 51, 52, 53 transmit the condition signals detected or captured by them to the first control unit 40 of the vehicle 10. Furthermore, at least some of the second sensors 51, 52, 53 transmit their measurement results directly to a drive system 30 of the vehicle 10.

The vehicle 10 further has a first communication module 20 with a memory 21 and one or more transponders or transceivers 22. The transponders 22 are a cellular, WLAN, GPS or Bluetooth transceiver or the like. Also preferably, the transponder 22 is designed for communicating via a cellular network, for example an LTE, LTE-A or 5G cellular network. The transponder 22 communicates with the internal memory 21 of the first communication module 20, for example, via a suitable data bus. By means of the transponder 22 the current position of the vehicle 10 can be determined by communicating with a GPS satellite 61, for example, and can be stored in the internal memory 21. Likewise, authorization information stored in the memory 21 can be transmitted to an external communication module by means of the transponder 22. The first communication module 20 communicates with the first control unit 40.

Moreover, the first communication module 20 is configured to communicate with a server 70, in particular, a fourth communication module 71 of the server 70, for example, via a UMTS (Universal Mobile Telecommunication Service) or LTE (Long Term Evolution) cellular network. The first communication module 20 is further configured to communicate with a second communication module 81 of a service station 80 and a third communication module 91 of a service module 90. The communication takes place directly via a V2X communication or via a cellular network. The communication via the cellular network takes place via one or more base stations 62.

The vehicle 10 further has the drive system 30 configured for fully autonomous driving operation, in particular for lateral and longitudinal guidance, of the motor vehicle 10. The drive system 30 has a navigation module 32 configured for calculating routes between a start and a target point and for determining maneuvers to be carried out by the vehicle 10 along this route. Moreover, the drive system 30 has an internal memory 31, for map materials, for example, which communicates with the navigation module 32, for example, via a suitable data bus. At least part of the second sensors 51, 52, 53 of the vehicle 10 transmits its measurement results directly to the drive system 30. This data that is directly transmitted to the drive system is in particular location and movement information of the vehicle 10. They are preferably detected by speed sensors, acceleration sensors, tilt sensors, etc.

The vehicle 10 further has an electric drive system 35 providing the functionalities necessary for electrically driving the vehicle 10. The electric drive system 35 has, in particular, an electrical energy storage unit 36 that provides an electric motor 37 with the electric energy required for driving the vehicle 10. The electric drive system 35 further has a charging device (not shown) for charging the energy storage unit 36. Moreover, the vehicle 10 may be a hybrid vehicle having a hydrogen tank for supplying a fuel cell system arranged in the vehicle 10.

The vehicle 10 further has a first control unit 40 configured for carrying out the steps of the vehicle in the method according to the present disclosure. For this purpose, the first control unit 40 has an internal memory 41 and a CPU 42 which communicate with one another via a suitable data bus, for example. Moreover, the first control unit 40 is in communication connection with at least the first sensors 11, 12, 13 the second sensors 51, 52, 53, the first communication module 20 and the drive system 30, for example, via one or more respective CAN connections, one or more respective SPI connections, or other suitable data connections.

The system according to the present disclosure for carrying out the method according to the present disclosure further has a server 70. The server 70 is preferably operated by a fleet operator of an autonomous vehicle fleet in the context of a car sharing concept, for example, by a service provider for vehicle cleaning and/or by a vehicle manufacturer. The server 70 has a fourth communication module 71 configured for communicating using the same protocol as the first communication module 20 of the vehicle 10. The server 70 further has a fourth control unit 72.

The fourth control unit 72 is preferably designed to establish a communication between the vehicle 10 and the service station 80, to determine a utilization of the autonomous vehicle fleet, and to transmit first information about a service need of the vehicle 10 received from the vehicle 10 to the service station 80 based on the utilization of the vehicle fleet.

The system according to the present disclosure for carrying out the method according to the present disclosure further has a first service station 80 and at least one service module 90.

The service station 80 has a second communication module 81 designed for communication with the first communication module 20 of the vehicle 10, for communication with the fourth communication module 71 of the server 70, and for communication with the third communication module 91 of a service module 90. The second communication module 81 is, in particular, configured for communication using the same protocol as the first communication module 20 of the vehicle 10, as the fourth communication module 71 of the server 70, and as the third communication module 91 of the service module 90.

Moreover, the service station 80 has a control unit 82 having a memory 83 and a CPU 84 that communicate with one another via a suitable data bus such as a CAN bus or an SPI bus. The service station 80 further has at least one service module 90, preferably several service modules 90. The components of the service module 90 are similar to those of the service module 90 explained below. Thus the service station 80 has at least one service module 90 and/or is associated with at least one independent service module 90.

Each of the service modules 90 is designed for communicating with the second control unit 82. The second control unit 82 is designed to, in communication with the second communication module 81 and the at least one service module 90, carry out the steps of the method according to the present disclosure carried out by the service station 80. The second control unit 82 is, in particular, designed to carry out the steps of the service station 80 in the method according to the present disclosure.

The system according to the present disclosure has at least one service module 90. The service station 90 has a second communication module 91 designed for communication with the first communication module 20 of the vehicle 10, for communication with the fourth communication module 71 of the server 70, and for communication with the second communication module 81 of the service station 80. The third communication module 91 is, in particular, configured for communication using the same protocol as the first communication module 20 of the vehicle 10, as the fourth communication module 71 of the server 70, and as the second communication module 81 of the service station 80.

Moreover, the service station 90 has a third control unit 92 having a memory and a CPU, for example, that communicate with one another via a suitable data bus such as a CAN bus or an SPI bus. The service module 90 further has means for carrying out a service action 99. Embodiments of the means for carrying out a service action 99 are explained below for a first service module 95, a second service module 96 and a third service module 97.

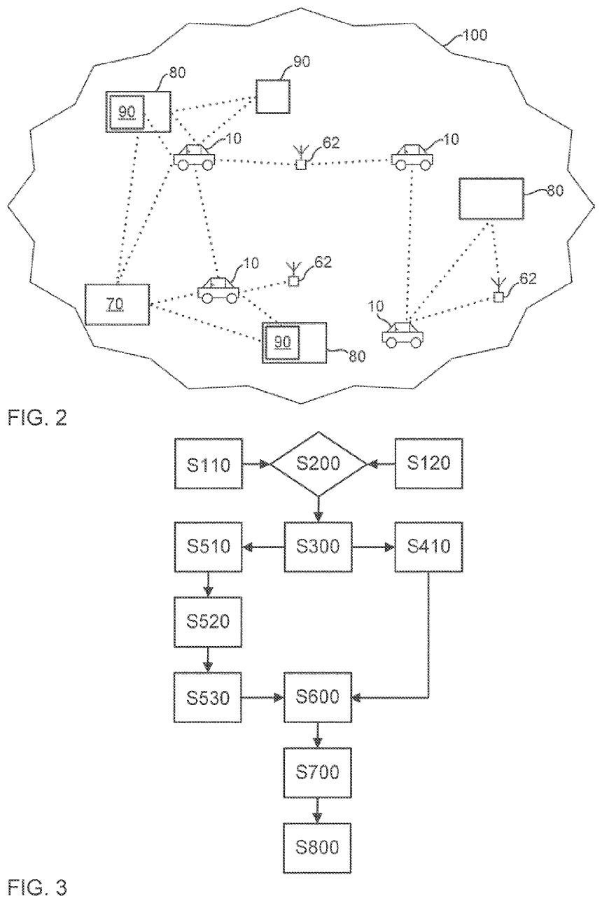

FIG. 2 shows a schematic illustration of an operating area 100 for carrying out the method according to the present disclosure by means of the system shown in FIG. 1. The operating area 100 extends over an urban agglomeration, such as a city or city center. A plurality of autonomous vehicles 10 is located within the operating area 100, each of which has a basic configuration, as described in reference to FIG. 1. Each of the autonomous vehicles 10 can be called-up by users of a car sharing service or, on the other hand, be permanently assigned to a certain user.

The operating area 100 has a plurality of service stations 80 and service modules 90. Furthermore, a server 70 is arranged in the operating area 100. The autonomous vehicles 10 are designed for communications among each other, in particular, by means of the first communication module 20 and via base stations 62 of a cellular network. The vehicles 10 are further designed for communication with the service stations 80, the service modules 90 and the server 70. These elements communicate with each other directly or via base stations 62 of a cellular network. Moreover, the other components of the system illustrated in FIG. 2 are also designed for direct or indirect communication with each other, such as a service station 80 with the server 70 and the service modules 90, and the server 70 with the service modules 90. Connections are indicated in FIG. 2 with dashed lines.

FIG. 3 shows a schematic flow diagram of the method according to the present disclosure according to a form of execution.

Finally, in a step S110 of the method according to the present disclosure, the service station 80 receives, by means of the second communication module 81, first information about a service need of a vehicle 10 from the first communication module 20 of the vehicle 10. The first information defines, in particular, the type (soiling) and degree (interior) of the service need. In a step S120 of the method, the service station 80 receives, by means of the second communication module 81, second information about an availability or a utilization of at least one service module 90.

In a step S200, the control unit 82 of the service station 80 determines, based on the first information and based on the second information, whether a service module available for carrying out a service action corresponding to the service need exists. In the illustrated form of execution of the method, the service station 80 identifies a first service module 95 that is designed and available for carrying out an interior cleaning of the vehicle 10. Subsequently, in a step S300, the service station transmits positioning information of the identified service module 90, 95 to the vehicle 10, and further transmits booking information including an identifier of the vehicle 10 and a specification of the service action to be carried out to the service module 90, 95. The identifier of the vehicle was preferably included in the first information.

The booking information preferably also comprises a specification of a time window for carrying out the service action. The time window was preferably determined by the service station based on a current position and utilization of the vehicle 10 and, if applicable, a current traffic situation. The time window was also preferably determined based on usual utilization intervals of the vehicle 10. Thus, depending on its urgency, the service action preferably takes place at times of usually low utilization of the vehicle 10, for example at night. Also preferably, the positioning information transmitted to the vehicle 10 also has information about the time window for carrying out the service action.

Depending on the type of positioning information, the vehicle 10 either carries out an autonomous drive to the service module 95 in step S410 or an autonomous drive to the service station 80 in step S510. In step S410, the positioning information includes the coordinates of the service module 95 and, upon arrival at the service module 95, the vehicle 10 is identified by its identifier transmitted from the vehicle 10 to the service module 95, which identifier corresponds to the identifier in the booking information.

In step S510, the positioning information includes the coordinates of the service station 80 and the vehicle is identified upon arrival at the service station 80 based on its identifier transmitted from the vehicle to the service station 80, which identifier corresponds to the identifier in the first information. In step S520, the service station 80 further determines the available service module 95 identified for the vehicle 10 and monitors an autonomous drive of the vehicle 10 to the service module 95, preferably by remotely controlling the vehicle 10 and infrastructure components of service module 95.

Finally, in step S530, upon arrival at the service module 95, the vehicle 10 is identified by its identifier transmitted from the vehicle 10 to the service module 95, which identifier corresponds to the identifier in the booking information.

In step S600, the service module 95 transmits vehicle settings associated with the service action booked for the vehicle 10 to the vehicle 10, for example, an instruction to move the vehicle seats so that a cleaning arm or robot 951 can be inserted into the vehicle 10. In step S700, the service module 95 receives a notification from the vehicle 10 that the vehicle settings have been made and carries out the service action corresponding to the service need of the vehicle 10 on the vehicle 10 based on the booking information, the identifier and the notification. In step S800, the carrying out of the service action is completed, the service module 95 transmits an availability information to the service station 80 (second information) and the service station 80 monitors an autonomous drive of the vehicle 10 out of the service module 95.

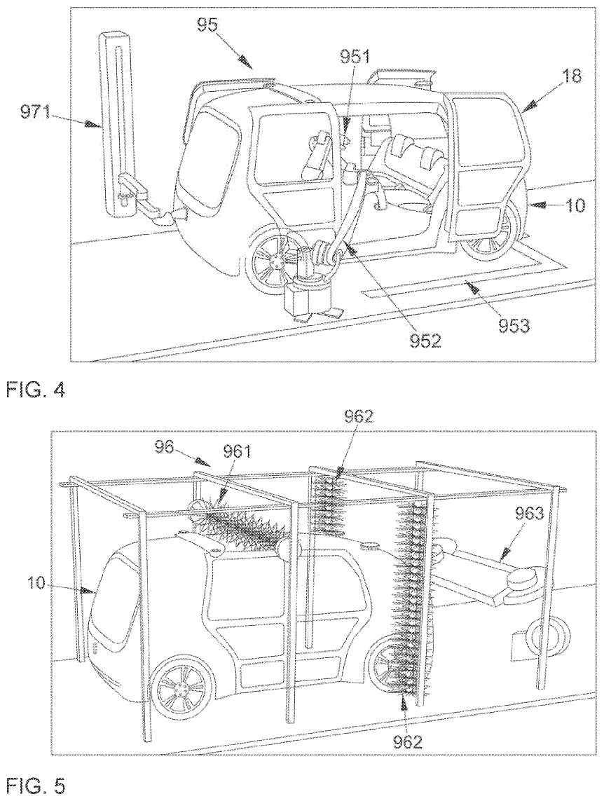

With reference to FIGS. 4 through 7, various embodiments of the service modules 90 according to the present disclosure that are arranged within or associated with a service station 80 are explained below.

FIG. 4 shows a schematic illustration of a first service module 95 for interior cleaning of the vehicle 10. In order to carry out an interior cleaning of the vehicle 10, said vehicle drives into the service module 95 to come to a stop there at a stop position 953. As soon as the vehicle 10 stops at the stop position 953, the vehicle doors 18 of the vehicle 10 automatically open. This is preferably prompted by the control unit 92 of the first service module 95, which communicates directly with the control unit 40 of the vehicle 10. As soon as the vehicle doors 18 are open, a first robotic arm 951 and a second robotic arm 952 are inserted into the vehicle 10. Arranged on the robotic arms 951, 952 are tools for carrying out an interior cleaning, in particular, a vacuum cleaner nozzle, an applicator for applying a cleaning agent and means for cleaning the upholstery. The service module 95 shown in FIG. 3 further has a charging connection 971 for filling an electrical energy storage unit 36 of the vehicle 10.

FIG. 5 shows a schematic illustration of a second service module 96 for exterior cleaning of the vehicle 10. The second service module 96 corresponds largely to automatic car washes known in the prior art for autonomous exterior cleaning of a vehicle 10. The second service module 96, in particular, has means (not shown) for applying a cleaning fluid, such as nozzles for applying a soapy solution. Moreover, the second service module 96 has a rotatable upper drive system 961 and rotatable lateral drive systems 962 for distributing the cleaning fluid and for loosening dirt. The second service module 96 further has a blow dryer 963 for drying the vehicle 10. The second service module 96 preferably communicates directly with the control unit 40 of the vehicle 10, for example, to ensure that all windows of the vehicle 10 are closed.

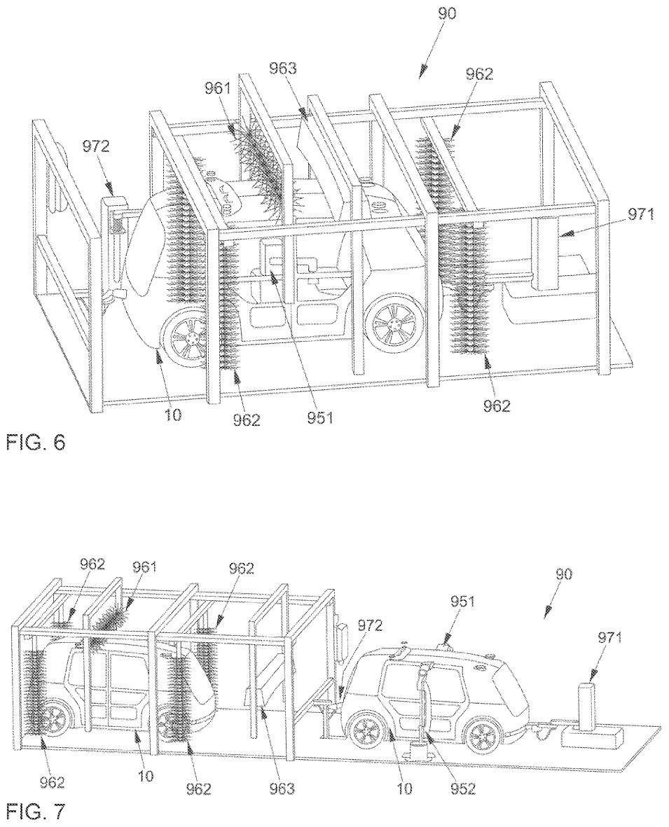

FIG. 6 shows a schematic illustration of a service station 80 according to the present disclosure having the first service module 95 of FIG. 4 and the second service module 96 of FIG. 5, according to an embodiment. In this embodiment of the service station 80, the first and second service modules 95, 96 are a in a common area of the service station 80. Thus the service station 80 according to this embodiment enables at least in part that the exterior cleaning and the interior cleaning are carried out simultaneous.

A sequence of the autonomously carried out service action in the service station 80 according to this embodiment starts with the autonomous entry of the vehicle 10 into the first service station 80. This entry is preferably carried out by the drive system 30 of the vehicle 10, in particular using position information or navigation information received from the service station 80 or one of the service modules 95, 96. Using the position information, the vehicle 10 itself can identify navigation information and maneuvers to be carried out autonomously. Using the navigation information, the vehicle 10 itself can identify maneuvers to be carried out autonomously. Alternatively, the vehicle 10 is remotely controlled by the service station 80 or a service module 95, 96.

Provided the vehicle 10 has reached a stop position in the service station 80, the doors 18 of the vehicle 10 open automatically and a mobile cleaning robot 951 moves autonomously into the interior or is inserted into the interior of the vehicle 10. As soon as the doors 18 of the vehicle 10 close, the mobile cleaning robot 951 starts the interior cleaning and starts an exterior cleaning of the vehicle 10 by means of the second service module 97, in particular by means of the drive systems 961, 962 and the blow dryer 963.

As soon as the exterior cleaning and the interior cleaning are completed, the doors 18 open and the mobile cleaning robot 951 moves out or is lifted out. If desired, a check of the interior and/or exterior cleaning of the vehicle 10 is carried out via cameras (not shown) or other sensors of a second control module. Once this check has been completed, the vehicle 10 drives autonomously out of the service station 80.

FIG. 7 shows a schematic illustration of a service station 80 according to the present disclosure having the first service module 95 of FIG. 4 and the second service module 96 of FIG. 5, according to a further embodiment. In this further embodiment of the service station 80, the first service module 95 and the second service module 96 are arranged in different areas of the service station 80. According to this embodiment, the service modules 95, 96 may also be just associated with the service station 80, i.e., arranged outside of and/or at a distance from the service station 80. The illustration in FIG. 6 with service modules 95, 96, 97 arranged linearly one behind the other is thus merely intended to provide a schematic illustration of the functional arrangement of the modules.

A sequence of the autonomously carried out service action in the service station 80 according to this further embodiment starts with the autonomous entry of the vehicle 10 into a first area of the first service station 80. This entry is preferably carried out by the drive system 30 of the vehicle 10, in particular using position information or navigation information received from the service station 80 or one of the service modules 95, 96. Using the position information, the vehicle 10 itself can identify navigation information and maneuvers to be carried out autonomously. Using the navigation information, the vehicle 10 itself can identify maneuvers to be carried out autonomously. Alternatively, the vehicle 10 is remotely controlled by the service station 80 or a service module 95, 96.

Provided the vehicle 10 has reached a stop position in the first area of the service station 80, the exterior cleaning of the vehicle 10 by means of the second service module 96 arranged in the first area, in particular, by means of the drive systems 961, 962 and the blow dryer 963 starts. As soon as the exterior cleaning is completed, the exterior cleaning of the vehicle 10 is checked by means of cameras or sensors (not shown), if desired. As soon as the exterior cleanings and/or the checking is completed, the vehicle 10 autonomously drives to a second area of the service station 80 downstream of the first area or is transported from the first to the second area by means of a conveyor of the service station 80.

Provided the vehicle 10 has reached a stop position in the second area of the service station 80, the doors of the vehicle 10 open automatically and robotic arms 951, 952 are autonomously moved into the interior. An interior cleaning of the vehicle 10 by means of the tools located at the robotic arms 951, 952 starts. Simultaneously, an electrical energy storage unit 36 of the vehicle 10 is filled by means of a charging connection 971 and the hydrogen tank of the vehicle 10 is filled by means of a hydrogen filling device 972. As soon as the interior cleaning is completed, the robotic arms 951, 952 are moved out of the vehicle 10. If desired, the interior cleaning of the vehicle 10 is checked via cameras or other sensors (not shown) of a second control module. As soon as this check is completed, the filling elements of the charging connection 971 and the hydrogen filling device 972 are removed and the vehicle 10 autonomously drives out of the service station 80. In an alternative embodiment, the blow dryer 963 is arranged in the second area and the vehicle 10 is dried in parallel with the interior cleaning and refilling of the energy storage unit 36.

### LIST OF REFERENCE NUMBERS

10 Motor vehicle
11 First sensor
12 Second sensor
13 Third sensor
18 Vehicle door
20 First communication module
21 Memory
22 Transponder
30 Driving system
31 Memory
32 CPU
35 Electric driving system
36 Electrical energy storage unit
37 Electric motor
40 First control unit
41 Memory
42 CPU
51 Forth sensor
52 Fifth sensor
53 Sixth sensor
61 GPS satellite
62 Cellular station
63 Other vehicle
70 Server
71 Forth communication module
72 Forth control unit
80 Service station
81 Second communication module
83 Memory
84 CPU
90 Service module
91 Third communication module
92 Third control unit
99 Means for carrying out a service action
95 First service module
951 Cleaning robot
952 Cleaning robot
953 Stop position
96 Second service module
961 Top cleaning brush
962 Lateral cleaning brush
963 Blow dryer
97 Third service module
971 Charging connection
972 Hydrogen filling device

1-15. (canceled)

16. A method for operating a network service station for a vehicle, comprising:
receiving first information about a service need of the vehicle;
receiving second information about a utilization of the service module;
identifying at least one available service module based on the first information and the second information; and
transmitting booking information to the at least on identified service module and location information of the at least one identified service module to the vehicle.

17. The method according to claim 16, wherein the first information is received from the vehicle or the network, the first information comprising an identifier of the vehicle, and wherein the booking information comprises the identifier of the vehicle.

18. The method according to claim 16, further comprising identifying the vehicle based on the identifier when the vehicle is in proximity to one of the at least one identified service module.

19. The method according to claim 16, further comprising:
identifying the vehicle upon arrival at the service station;
transmitting position information of the at least one identified service module and/or navigation data to the vehicle; and
monitoring a drive of the vehicle to one of the at least one identified service module within the service station.

20. The method according to claim 16, further comprising:
transmitting at least one vehicle setting from the at least one identified service module to the vehicle;
receiving, via the at least one identified service module, a notification of a confirmation or non-implementation of the at least one vehicle setting from the vehicle;
carrying out of at least one service action on the vehicle by the service module based on the received booking information and the received notification.

21. The method according to claim 16, wherein a service module configured for carrying out a service action is specified via the first information is identified as available service module.

22. The method according to claim 16, further comprising:
transmitting an occupancy indication from the at least one identified service module to the control unit of the service station at the start of the service action; and
transmitting an availability indication from the at least one identified service module to the control unit of the service station after completion of the service action.

23. The method according to claim 16, wherein the first information comprises information about a condition characteristic of the vehicle and specifies that an actual condition of the vehicle deviates from a desired condition specified for the vehicle or any vehicles in at least one specific characteristic.

24. The method according to claim 16, wherein the service need comprises at least one of a soiling of the vehicle, a low fill level of an energy storage unit, an error message of the vehicle and/or a maintenance need of the vehicle.

25. The method according to claim 24, wherein the service action comprises at least one corresponding one of a cleaning of the vehicle, a filling of the energy storage unit, a repair of the vehicle and a maintenance need of the vehicle.

26. A system for carrying out a networked service action on a vehicle, comprising:
a service station comprising a communication module configured to communicate with a vehicle and/or a server of a fleet operator and a second control unit; and
a plurality of service modules configured to carry out a service action on the vehicle, wherein the plurality of service modules and service station are configured to:
receive first information about a service need of the vehicle;
receive second information about a utilization of the service module;
identify at least one available service module based on the first information and the second information; and
transmit booking information to the at least on identified service module and location information of the at least one identified service module to the vehicle.

27. The system according to claim 26, wherein the plurality of service modules and service station are configured to receive the first information from the vehicle or the network, the first information comprising an identifier of the vehicle, and wherein the booking information comprises the identifier of the vehicle.

28. The system according to claim 26, wherein the plurality of service modules and service station are configured to identify the vehicle based on the identifier when the vehicle is in proximity to one of the at least one identified service module.

29. The system according to claim 26, wherein the plurality of service modules and service station are configured to:
identify the vehicle upon arrival at the service station;
transmit position information of the at least one identified service module and/or navigation data to the vehicle; and
monitor a drive of the vehicle to one of the at least one identified service module within the service station.

30. The system according to claim 26, wherein the plurality of service modules and service station are configured to:
transmit at least one vehicle setting from the at least one identified service module to the vehicle;
receive, via the at least one identified service module, a notification of a confirmation or non-implementation of the at least one vehicle setting from the vehicle;
carry out of at least one service action on the vehicle by the service module based on the received booking information and the received notification.

31. The system according to claim 26, wherein a service module configured for carrying out a service action is specified via the first information is identified as available service module.

32. The system according to claim 26, wherein the plurality of service modules and service station are configured to:
transmit an occupancy indication from the at least one identified service module to the control unit of the service station at the start of the service action; and
transmit an availability indication from the at least one identified service module to the control unit of the service station after completion of the service action.

33. The system according to claim 26, wherein the first information comprises information about a condition characteristic of the vehicle and specifies that an actual condition of the vehicle deviates from a desired condition specified for the vehicle or any vehicles in at least one specific characteristic.

34. The system according to claim 26, wherein the service need comprises at least one of a soiling of the vehicle, a low fill level of an energy storage unit, an error message of the vehicle and/or a maintenance need of the vehicle.

35. The system according to claim 34, wherein the service action comprises at least one corresponding one of a cleaning of the vehicle, a filling of the energy storage unit, a repair of the vehicle and a maintenance need of the vehicle.
